(19) United States
(12) Patent Application Publication
(10) Pub. No.: US 2026/0187280 A1
(43) Pub. Date: Jul. 2, 2026

(54) PERSONAL INFORMATION REDACTION

(71) Applicants: American Express Travel Related Services Company, Inc., New York, NY (US); American Express Services Europe Limited, London (GB)

(72) Inventors: Charles Robert Boxer, Brighton (GB); Emery Schoenly, Salisbury, CT (US)

(21) Appl. No.: 19/002,031

(22) Filed: Dec. 26, 2024

(51) Int. Cl. G06F 21/62

(52) U.S. Cl. CPC G06F 21/6254

(57) ABSTRACT

Disclosed are various approaches for utilizing a machine learning model service to detect and redact personal information based at least in part on a calculated likelihood of identification score. To begin, a computing device can receive input data. Then, the computing device can detect individual items of personal information present in the input data. Next, the computing device can generate a category tag for individual items of the detected personal information based at least in part on a category of the detected personal information. The computing device can then determine a likelihood of identification score for the input data. Next, the computing device can determine the likelihood of identification score is above a predefined threshold. Finally, the computing device can redact individual items of personal information present in the input data based at least in part on the likelihood of identification score.

### BACKGROUND

Many institutions collect information from their clients and customers as part of their daily operation. These entities often amass vast quantities of data from these collection practices. However, privacy laws and regulations sometimes require entities in possession of data to use the least amount of identifying personal information possible to prevent identification when processing the data. Some of these various privacy laws and regulations may require PII and indirect identifying information be redacted or removed from data. Entities often over-redact their data sets to ensure compliance. All personal data is often removed regardless of its identifying qualities. In this way, entities can be sure to prevent cumulative indirect identification and preclude noncompliance with the various privacy laws and regulations. Over-redaction, however, can present problems with respect to training machine learning models or processing data using machine learning models. High quality data or data sets are important for machine learning and/or data analysis purposes, but the quality and size of the data sets are often limited by compliance with these various privacy laws.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flow chart illustrating one example of functionality implemented as portions of an application executed in a computing environment in the network environment of FIG. 1 according to various embodiments of the present disclosure.

FIGS. 3-6 are user interface diagrams illustrating an example of a user experience according to various embodiments of the present disclosure.

### DETAILED DESCRIPTION

Disclosed are various approaches for utilizing a machine learning model service to detect and redact personal information based at least on a calculated likelihood of identification score. Entities often collect information from their customers as part of their daily operation that results in vast accumulated amounts of data. These data sets are valuable for machine learning and/or data analysis purposes, but the quality and size of data sets are often limited by various privacy laws and regulations. For example, privacy laws and regulations may require entities in possession of data to use the least amount of personal information possible when processing the data to prevent identification of individuals. Individuals may be identified directly from personal information or indirectly from a cumulation of personal information. Thus, non-identifying personal information can still become identifying when analyzed in conjunction with other data.

Detecting personal information within a data set for the purpose of conforming to privacy laws and regulations can be a time cumbersome process. This is compounded by the need to distinguish between direct identifying information (e.g., full name, address, government issues identification number, etc.) and indirect identifying information (e.g., surname, job title, geographic statistics, etc.). Analyzing the various combinations of personal information (e.g., name, address, job title, etc.) and known statistics (e.g., demographic data for various population characteristics such as age, gender, race, ethnicity, veteran status, family structure, income, poverty, employment, commuting, housing status, etc.) to determine which data points are personally identifying is restrictively time consuming. Given the nearly infinite variety of data sources and data sets, there is simply not enough time to manually scrutinize each possible combination of datum to precisely redact necessary personal information from the data sets, in most examples. Entities often instead over-redact personal information as a time and cost-effective, yet imprecise, approach to ensure compliance with all applicable privacy laws and regulations. This comprehensive redaction of all personal information, regardless of its direct or indirect identifying qualities, can leave the data set limited in its composition or of low quality for its intended purpose.

Accordingly, various embodiments of the present disclosure provide for a machine learning model service to analyze input data to identify personal information datapoints within the input data and calculate a likelihood of identification score based at least in part on the detected personal information and other known statistics. Various embodiments of the present disclosure allow for time-effective, precision redaction to exhibit highly accurate compliance with various data privacy laws and regulations. The various embodiments of the present disclosure enable precise analysis of each datapoint and its identifying qualities in isolation and in combination with other datapoints. The conclusion of this analysis is outputted in the form of a likelihood of identification score, a percentage representation of a probability of identifying an individual from the detected personal information. The likelihood of identification score can be calculated for the data set as a whole, for data attributable to an individual, and/or for each datapoint. The likelihood of identification score can also be analyzed through iterative recalculations to determine whether redaction is necessary or to determine an adequate level of redaction. By precisely determining possible direct and indirect identification based at least in part on the likelihood of identification score, the redaction process can be tailored to only redact the necessary datapoints. Selective redaction based at least in part on the calculated likelihood of identification score allows for higher and more consistent levels of redactions compared to manual redaction. By optimally redacting personal information, the machine learning model service can maintain the quality of the data set while most effectively complying with any applicable privacy laws and regulations. The various embodiments described in the present disclosure can also improve entities'ability to evidence to regulators the extent of redaction being performed. Evidence can be provided by quantifying the analysis of various personal information and the possible combinations of personal information with the likelihood of identification score.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

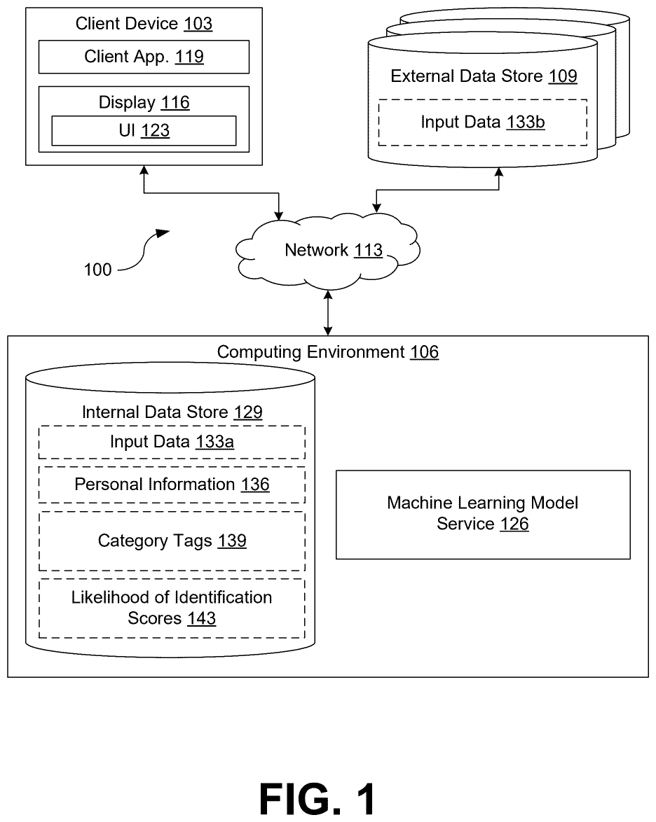

FIG. 1 represents a network environment 100 according to various embodiments. The network environment 100 can include a client device 103, a computing environment 106, and/or one or more external data store(s) 109, which can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks. In other words, any one or more of the computing environment 106 and its components, the client device 103 and the external data store 109 can be in wired or wireless communication with each other.

The client device 103 is representative of a plurality of client devices that can be coupled to a network 113. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 116, such as liquid crystal displays (LCDs), gas plasma-based flat panel displays, organic light emitting diode (OLED) displays, electrophoretic ink (“E-ink”) displays, projectors, or other types of display devices. In some instances, the display 116 can be a component of the client device 103 or can be connected to the client device 103 through a wired or wireless connection.

The client device 103 can be configured to execute various applications such as a client application 119 or other applications. The client application 119 can be executed in a client device 103 to access network content served up by the computing environment 106 or other servers, thereby rendering a user interface 123 on the display 116. To this end, the client application 119 can include a browser, a dedicated application, or other executable, and the user interface 123 can include a network page, an application screen, or other user mechanism for obtaining user input.

The computing environment 106 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 106 can employ a plurality of computing devices that can be arranged in one or more server banks or computer banks or other arrangements. Such computing devices can be located in a single installation or can be distributed among many different geographical locations. For example, the computing environment 106 can include a plurality of computing devices that together can include a hosted computing resource, a grid computing resource or any other distributed computing arrangement. In some cases, the computing environment 106 can correspond to an elastic computing resource where the allotted capacity of processing, network, storage, or other computing-related resources can vary over time. For example, the computing environment 106 can be implemented as a cloud computing system. For example, an implementation of the present disclosure could host the components depicted herein in a shared tenancy cloud computing environment (e.g., AMAZON® Web Services (AWS), MICROSOFT® AZURE®, GOOGLE® Cloud Compute (GCP), etc.).

Various applications or other functionality can be executed in the computing environment 106. The components executed on the computing environment 106 include a machine learning model service 126. The machine learning model service 126 is representative of any one or more of a variety of artificial intelligence (AI) technologies, such as a large language model (LLM), generative AI, variational autoencoders (VAEs), autoregressive models, recurrent neural networks (RNNs), or other form of AI. The machine learning model service 126 can represent any AI technology that can be executed to process, categorize, and analyze personal information. The machine learning model service 126 can process and/or analyze input data received by the computing environment 106 (either from an external data store or an internal data store). This can be done, for example, by receiving input data and repeatedly predicting the next word or token for a response to determine whether the data is personal information. Based at least in part on the detected personal information, the machine learning model service 126 can calculate the likelihood of identification score. In order to generate responses, the machine learning model service 126 can learn statistical relationships between words, phrases, or other tokens from a corpus of training text in a self-supervised or semi-supervised training process. Once the input data has been analyzed, the machine learning model service 126 can redact a portion of the personal information. The redacted data set can then be returned to the requesting client application 119 or client device 103.

Various other types of data can also be stored in an internal data store 129 that is accessible to the computing environment 106. The internal data store 129 can be representative of a plurality of internal data stores 129, which can include relational databases, hash tables, or similar key-value data stores, as well as other data storage applications or data structures. Moreover, combinations of these databases, data storage applications, and/or data structures may be used together to provide a single, logical, data store. The data stored in the internal data store 129 is associated with the operation of the various applications or functional entities described below. This data can include input data 133a (referred to generically as “input data 133” and individually as “input datum 133”), personal information 136, category tags 139, likelihood of identification scores 143, and potentially other data.

The input data 133 can represent the data that is submitted to the machine learning model service 126 for analysis and redaction. For example, the input data 133 can represent raw data that can be processed by the machine learning model service 126 to detect and/or redact personal information 136. The input data 133 can include many forms of data such as personal information 136 (e.g., name, address, phone number, etc.) and non-personal information (e.g., location statistics, demographic statistics, types of devices, cookies or anonymous identifiers, time spent on a website or app, etc.). The input data 133 can encompass all data uploaded to the machine learning model service 126.

The personal information 136 can represent information that relates to an identified or identifiable individual. Personal information 136 can be used in isolation or in combination to identify an individual. Directly identifying personal information is referred to as personally identifying information (PII). However, non-personally identifying information can still constitute identifying personal information when combined to indirectly identify an individual. For example, the personal information 136 can represent information such as a first, middle, and/or last name; address; government issued identification number (e.g., Social Security number (SSN)); religion; contact information (e.g., phone number, email address, etc.); banking information (e.g., account number, credit/debit card number, etc.); healthcare information (e.g., medical records, insurance information, etc.); transaction information (e.g., transaction history, payment instruments, confirmations, etc.); or any other suitable personal data that relates to an individual.

The category tags 139 can include tags categorizing each individual item of detected personal information 136. The category tags 139 can be generated by the machine learning model service 126 for individual items of the detected personal information 136 based at least in part on a category of the detected personal information 136 present in the input data 133. For example, a category tag 139 can identify a category for each item of personal information 136 such as a name, address, phone number, government issued identifier, or any other suitable category of personal information. Additionally, the category tags 139 can signal the presence of PII. For example, category tags 139 could be added to individual items of detected personal information classifying the data as PII.

The likelihood of identification score 143 can be a percentage representation of a chance of identifying an individual whose personal information 136 is present in the input data 133. For example, the likelihood of identification score 143 can be an output of the statistical analysis of the input data 133. Additionally, the likelihood of identification score 143 can be calculated for the input data 133 as a whole, data attributable to an individual, and/or each item of personal information 136. This statistical analysis can be based at least in part on the generated category tags 139, the amount of detected personal information 136, statistical tables on various demographics (e.g., number of residents in a country, frequency of spending at a merchant, number of people of a specific religion in a country, etc.) and/or any other information relating to the detected personal information 136. The likelihood of identification score 143 for each of the of individual items of personal information 136 can be used to calculate the likelihood of identification score 143 of a subset of data attributable to an individual. Similarly, the likelihood of identification score 143 of individual items of data and/or all data attributable to an individual can be used to calculate the likelihood of identification score for the data set.

Data can also be stored in an external data store 109 that is accessible to the computing environment 106. The external data store 109 can be representative of a plurality of external data stores 109, which can include relational databases, hash tables, or similar key-value data stores, as well as other data storage applications or data structures. Moreover, combinations of these databases, data storage applications, and/or data structures may be used together to provide a single, logical, data store. The data stored in the external data store 109 is associated with the operation of the various applications or functional entities described below. This data can include input data 133b and potentially other data.

Next, a general description of the operation of the various components of the network environment 100 is provided. Although the following description provides an example of the operation of the various components of the network environment 100, other operations are also encompassed by the various embodiments of the present disclosure.

To begin, a user of the client device 103 can use the client application 119 to submit a prompt to the machine learning model service 126. The prompt can represent input data 133 that, when provided to a machine learning model service 126, instructs the machine learning model service 126 to detect personal information 136. The input data 133 can be submitted, for example, through a web-form or other web-based interface provided by the machine learning model service 126. As another example, the input data can be transmitted to the machine learning model service 126 using an application programming interface (API) provided by the machine learning model service 126.

Turning to the various applications or other functionality that can be executed on the computing environment 106, the machine learning model service 126 can be executed to perform various actions. For example, the machine learning model service 126 can be executed to receive or obtain input data 133 from either the internal data store 129 (input data 133a) or the external data store 109 (input data 133b).

The machine learning model service 126 can analyze the input data 133 to detect and categorize any personal information 136. For example, the machine learning model service 126 can use learned statistical relationships between words, phrases, or other tokens to detect personal information 136 present in the input data 133. Once personal information 136 has been identified, the machine learning model can generate category tags 139 for each individual item of detected personal information 136.

Thus, the machine learning model service 126 can determine a likelihood of identification score 143 based at least in part on the generated category tags 139 and/or the amount of detected personal information 136. The user of the client device 103 can use the client application 119 to set a predefined threshold of allowable likelihood of identification score 143. Based at least in part on the determined likelihood of identification score 143 compared to the predefined threshold, the machine learning model service 126 can redact a portion of the personal information 136. Alternatively, the machine learning model service 126 can be set to redact personal information 136 based at least in part on other predefined constraints. For example, a constraint could be to redact all PII or any other specific category tags 139 of personal information 136 regardless of the likelihood of identification score 143.

The machine learning model service 126 can iteratively redact personal information 136, recalculating the likelihood of identification score 143 each time. Once an acceptable likelihood of identification score 143 has been reached through redaction, the machine learning model can send the redacted data to the client device 103. The redacted data can, in some examples, retain the generated category tags 139 and likelihood of identification score(s) 143.

Additionally, the machine learning model service 126 can also determine personal information 136 that does not need to be redacted based at least in part on its lack of effect on the likelihood of identification score 143. For example, if a personal information 136 data point does not affect the likelihood of identification score 143 when redacted, then the data point does not necessarily need to be redacted. By iteratively redacting personal information 136 and recalculating the likelihood of identification score 143, the machine learning model service 126 can determine the most effective items of personal information 136 to redact. This analysis allows the machine learning model service 126 to achieve adequate redaction while maintaining the quality of the data set for its intended purpose.

In some examples, the machine learning model service 126 can also generate synthetic data to replace the redacted personal information 136. By replacing the redacted personal information 136 with synthetic data, the machine learning model service 126 can retain the quality of the data set without jeopardizing the security of personal information 136 present in the input data 133.

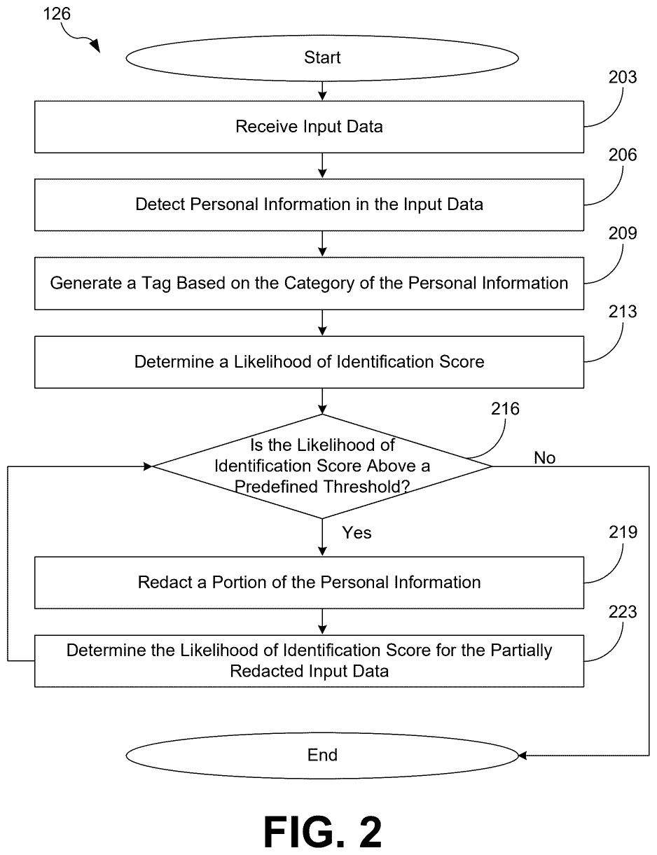

Referring next to FIG. 2, shown is a flowchart that provides an example of the operation of a portion of the machine learning model service 126. The flowchart of FIG. 2 provides merely one example of the many different types of functional arrangements that can be employed to implement the operation of the depicted portion of the machine learning model service 126. As an alternative, the flowchart of FIG. 2 can be viewed as depicting an example of elements of a method implemented within the network environment 100.

Beginning with block 203, the machine learning model service 126 can receive input data 133. For example, the user interface 123 of the client device 103 could prompt the user to select an input data 133 to submit to the machine learning model service 126. In some examples, the input data 133a can be received from the internal data store 129. Alternatively, the input data 133b can be received or obtained from the external data store 109.

Then, at block 206, the machine learning model service 126 can process the input data 133 to detect any personal information 136 present in the input data 133 received at block 203. For example, the machine learning model service 126 can employ learned statistical relationships between words, phrases, or other tokens to detect personal information 136.

Moving on to block 209, the machine learning model service 126 can generate a category tag 139 for each piece of personal information 136 detected at block 203. The category tag 139 can be based at least in part on the category of the personal information 136. For example, the category tags 139 can categorize the detected personal information 136 (e.g., name, government issued identification number, address, etc.). The category tags 139 can also flag the presence of PII.

At block 213, the machine learning model service 126 can determine a likelihood of identification score 143. The likelihood of identification score 143 can be based at least in part on the amount of personal information 136 as detected at block 206 and type of category tags 139 generated at block 209. As an example, input data 133 with only one entry of personal information (e.g., a name) may not have as high of a likelihood of identification score 143 as input data 133 with two entries of personal information (e.g., a name and an address). Further, in some examples, a category tag 139 indicating an item of PII can cause a calculation of a higher likelihood of identification score 143 compared to a category tag 139 indicating a non-identifying item of personal information 136. For example, the machine learning model service 126 can determine that a data set with a large amount of personal information 136 and several category tags 139 relating to PII has a high likelihood of identification score 143 because it is likely an individual could be identified using the information present in this data set. Additionally, the machine learning model service 126 could generate a list of individuals who can be identified from the detected personal information 136. Based at least in part on the contents of this list, the machine learning model service 126 could generate a likelihood of identification score 143. Moreover, the likelihood of identification score 143 can be determined by the machine learning model service 126 on a per item, individual, and/or data set basis.

Subsequently, at block 216, the machine learning model service 126 can determine whether the likelihood of identification score 143 is above a predefined threshold. The predefined threshold can be set on a basis of per item of personal information 136, per subset of data attributable to an individual, and/or for the whole data set. For example, a user of the client device 103 can set a predefined threshold of 40% for the data set as a whole. Therefore, any likelihood of identification score 143 calculated for the data set to be greater than 40% would exceed this threshold. Alternatively, in some examples, the predefined threshold could be set at 50% for each subset of data attributable to an individual. If the likelihood of identification score 143 is below the predefined threshold, the process can end. This would represent a determination that no data needs to be redacted to achieve the threshold likelihood of identification score 143. However, if the likelihood of identification score 143 is above the predefined threshold, the process can proceed to block 219.

Proceeding to block 219, the machine learning model service 126 can redact a portion of the personal information 136. Based at least in part on the likelihood of identification score 143 exceeding the predefined threshold or other predefined constraints, the machine learning model service 126 can redact personal information 136 in the input data 133. In various examples, the machine learning model service 126 can employ various redaction methods. Redaction methods can be varied to generate a likelihood of identification score 143 below the predefined threshold. The redaction of personal information 136 can be on a per item basis, per individual basis, per category basis, and/or any other suitable basis. In some examples, redaction can be set for specific categories and/or any other similar predefined constraint. For example, the machine learning model service 126 can be set to redact all personal information 136 detected to represent PII.

Next, at block 223, the machine learning model service 126 can calculate a likelihood of identification score 143 for the partially redacted input data 133. Once data has been redacted, the machine learning model service 126 can then recalculate the likelihood of identification score 143 based at least in part on the redacted data set. This repetitive process can ensure sufficient redaction of the data set. At the completion of block 223, the process can be reverted to block 216 to re-calculate the likelihood of identification score 143 for the partially redacted input data 133. This cycle continues until the likelihood of identification score 143 is determined to be below the predefined threshold at block 223. Once the likelihood of identification score is deemed to be below the predefined threshold, the process can end.

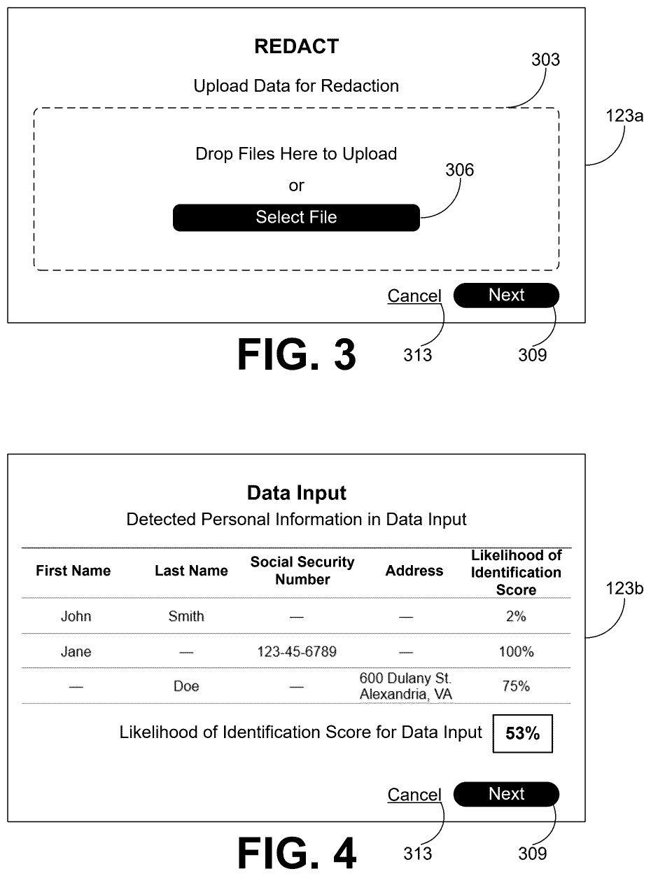

FIGS. 3-6 are user interface 123 diagrams illustrating an example of a user experience according to the previously described embodiments of the present disclosure. Specifically, the user interfaces 123a. . . 123d (collectively, “user interfaces 123”) of FIGS. 3-6 can be generated by the client application 119 and presented to a user using the display 116 of the client device 103 as can be appreciated. The user interfaces 123 can include a plurality of user interface elements. Examples of user interface elements for a user interface 123 can include an upload box 303, select file button 306, next button 309, cancel button 313, reload button 316, download button 319, back button 323, and done button 326. The plurality of user interface elements can be selected, manipulated, or otherwise interacted with by a user manipulating the client device 103.

Beginning with FIG. 3, an example of a user interface 123a is illustrated as the first step in the user experience. FIG. 3 shows an example user interface 123a for prompting a user to upload data for redaction. According to various nonlimiting examples, the redaction process can begin with the user interface 123 displaying an option to upload data for redaction. For example, the user could be presented with various options for uploading input data 133 by either placing files in the upload box 303 or selecting files using the select file button 306. Once the data has been selected, the user can continue through the client experience by selecting the next button 309. Alternatively, the user can abort the redaction process by selecting the cancel button 313.

Referring now to FIG. 4, another example of a user interface 123b is illustrated as the next step in the user experience continuing from FIG. 3. FIG. 4 shows an example user interface for presenting the detected personal information 136 and the likelihood of identification score 143 ascertained by the machine learning model service 126. In one example, the personal information 136 can be sorted by individual. The dashes in FIG. 4 represent information that was not detected in the input data 133. Moreover, FIG. 4 illustrates one example of determining a likelihood of identification score 143 for each individual as well as the data set as a whole. At this point in the client experience, the user is given the option to either select the cancel button 313 to abort the redaction process or the next button 309 to continue the redaction process.

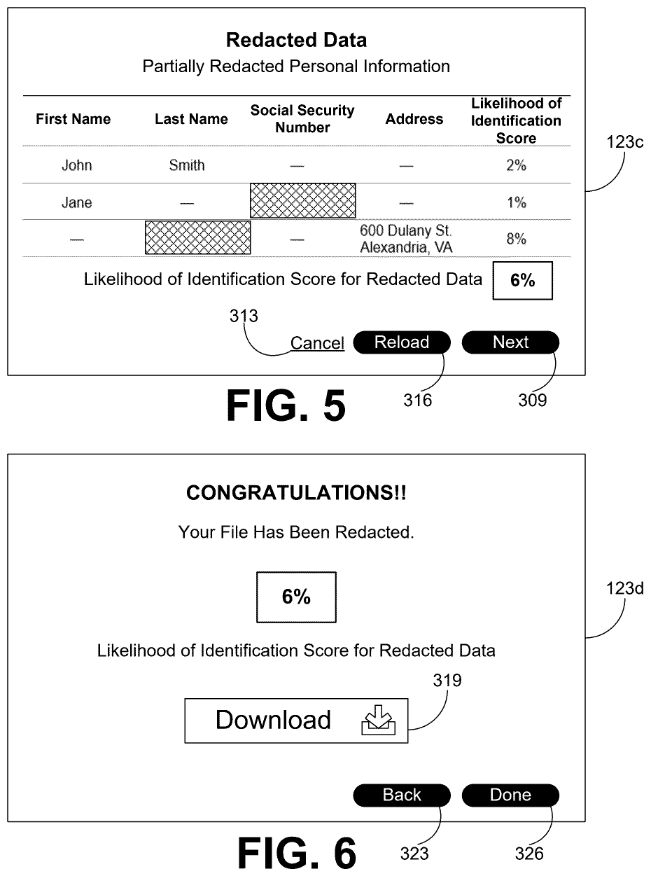

Moving to FIG. 5, another example of a user interface 123c is illustrated as the next step in the user experience continuing from FIG. 4. FIG. 5 illustrates an example user interface for presenting a redacted data set. The redacted personal information 136 can be represented by the boxes with crosshatched lines. In this example, the personally identifying government issued identification number and last name are redacted. The redaction of these data entries can result in a reduction to both of their respective likelihood of identification scores 143 as well as the likelihood of identification score 143 for the data set, all of which were recalculated by the machine learning model service 126. Once again, the user can be given the option to abort the redaction process by selecting cancel button 313 or to proceed with redaction by selecting the next button 309. Additionally, the user can be given the option to select the reload button 316 which will result in a manual iteration of the redaction process. This iteration can be employed to further manipulate the likelihood of identification score 143.

Finally, at FIG. 6, another example of a user interface 123d is illustrated as the next step in the user experience continuing from FIG. 5. FIG. 6 shows an example user interface for presenting the redacted data file to the client. In some examples, the final calculated likelihood of identification score 143 for the data set can be displayed. The user can be given the option to download the redacted data file via the download button 319. The user can be given the option to continue to manipulate the data by selecting the back button 323 to return to the user interface presented in FIG. 5. The user can exit the redaction process by selecting the done button 326.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
at least one computing device comprising a processor and a memory; and
machine-readable instructions stored in the memory that, when executed by the processor, cause the computing device to at least:
receive input data;
detect individual items of personal information present in the input data;
generate a category tag for respective ones of the individual items of the detected personal information based at least in part on a category of the detected personal information;
determine a likelihood of identification score for the input data based at least in part on the category tag for respective ones of the individual items of the detected personal information in the input data and an amount of the detected personal information in the input data;
determine that the likelihood of identification score for the input data is above a predefined threshold; and
redact one or more of the individual items of the detected personal information present in the input data based at least in part on the likelihood of identification score.

2. The system of claim 1, wherein the machine-readable instructions, when executed by the processor, further cause the computing device to at least replace a redacted portion of the personal information with synthetic data.

3. The system of claim 1, wherein the machine-readable instructions, when executed by the processor, further cause the computing device to at least determine the likelihood of identification score for a partially redacted input data.

4. The system of claim 3, wherein the machine-readable instructions, when executed by the processor, further cause the computing device to at least:
determine that the likelihood of identification score for the partially redacted input data is above the predefined threshold; and
redact a category of the detected personal information present in the partially redacted input data based at least in part on the likelihood of identification score for the partially redacted input data.

5. The system of claim 3, wherein the machine-readable instructions, when executed by the processor, further cause the computing device to at least:
determine that the likelihood of identification score for the partially redacted input data is above the predefined threshold; and
redact one or more individual items of the detected personal information present in the partially redacted input data based at least in part on the likelihood of identification score for the partially redacted input data.

6. The system of claim 3, wherein the machine-readable instructions, when executed by the processor, further cause the computing device to at least determine that the likelihood of identification score for the partially redacted input data is below the predefined threshold.

7. The system of claim 1, wherein the machine-readable instructions that cause the computing device to detect personal information present in the input data, further cause the computing device to prompt the machine learning model to generate a list of individuals who can be identified from the personal information.

8. The system of claim 7, wherein the machine-readable instructions, when executed by the processor, further cause the computing device to at least redact a portion of the detected personal information relating to the list of individuals who can be identified from the personal information.

9. A method, comprising:
receiving input data;
detecting personal information present in the input data;
generating a category tag for individual items of the detected personal information based at least in part on a category of the detected personal information;
identifying a subset of the input data based at least in part on the detected personal information attributable to an individual whose personal information is present in the input data;
determining, a likelihood of identification score for the subset of the input data, based at least in part on the category tag for respective ones of the individual items of the detected personal information in the subset of the input data and an amount of the detected personal information in the subset of the input data;
determining that the likelihood of identification score for the subset of the input data is above a predefined threshold; and
redacting one or more individual items of the detected personal information present in the subset of the input data based at least in part on the likelihood of identification score.

10. The method of claim 9, further comprising replacing a redacted portion of the detected personal information with synthetic data.

11. The method of claim 9, further comprising determining the likelihood of identification score for a partially redacted subset of the input data.

12. The method of claim 11, further comprising:
determining that the likelihood of identification score for the partially redacted subset of the input data is above the predefined threshold; and
redacting individual items of the detected personal information present in the partially redacted subset of the input data based at least in part on the likelihood of identification score for the partially redacted subset of the input data.

13. The method of claim 11, further comprising determining that the likelihood of identification score for the partially redacted subset of the input data is below the predefined threshold.

14. The method of claim 9, wherein detecting personal information present in the input data, further comprises prompting the machine learning model service to generate a list of individuals who can be identified from the personal information.

15. A non-transitory, computer-readable medium comprising machine-readable instructions that, when executed by a processor of a computing device, cause the computing device to at least:
receive input data;
detect individual items of personal information present in the input data;
generate a category tag for respective ones of the individual items of the detected personal information based at least in part on a category of the detected personal information;
determine a likelihood of identification score for individual items of the detected personal information based at least in part on the category tag for respective ones of the individual items of the detected personal information;
determine that the likelihood of identification score for the individual items of the detected personal information is above a predefined threshold; and
redact one or more of the individual items of the detected personal information with the likelihood of identification score above the predefined threshold.

16. The non-transitory computer-readable medium of claim 15, wherein the machine-readable instructions further cause the computing device to at least replace the redacted individual items of the detected personal information with synthetic data.

17. The non-transitory computer-readable medium of claim 15, wherein the machine-readable instructions that cause the computing device to detect personal information present in the input data, further cause the computing device to prompt the machine learning model service to generate a list of individuals who can be identified from the personal information.

18. The non-transitory computer-readable medium of claim 15, wherein the machine-readable instructions further cause the computing device to at least determine, with the machine learning model, the likelihood of identification score of a partially redacted input data.

19. The non-transitory computer-readable medium of claim 15, wherein the machine-readable instructions, further cause the computing device to at least:
determine that the likelihood of identification score for the partially redacted input data is above the predefined threshold; and
redact one or more individual items of the detected personal information present in the partially redacted input data based at least in part on the likelihood of identification score.

20. The non-transitory computer-readable medium of claim 15, wherein the machine-readable instructions, further cause the computing device to at least determine that the likelihood of identification score for the partially redacted input data is below the predefined threshold.
